(19) United States
(12) Patent Application Publication
(10) Pub. No.: US 2009/0249669 A1
(43) Pub. Date: Oct. 8, 2009

(54) REFLECTIVE LABELS

(75) Inventors: Alex HENKEL, Walpole, NH (US); Jason WILDER, Troy, NH (US); Juan MUNOZ, Troy, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: ELECTRONIC IMAGING MATERIALS, INC., Keene, NH (US)

(21) Appl. No.: 12/098,841

(22) Filed: Apr. 7, 2008

(51) Int. Cl. G09F 3/10; B32B 37/12

(52) U.S. Cl. 40/675; 156/277

(57) ABSTRACT

A label, a method of forming a label, and a system for using the label. The label may include a substrate including a first surface and a second surface opposite the first surface. The label may also include an adhesive contacting at least a portion of the first surface, a liner contacting at least a portion of the adhesive, and a reflective layer contacting at least a portion of the second surface. The reflective layer includes a binder and a reflective flake. The liner may have a first reflectivity R₁ and the label may have a second reflectivity R₂. The label may reflect 10% to 50% of light incident to said label and R₁≠R₂.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### FIELD OF THE INVENTION

The present invention relates generally to labels and, more specifically, to labels including a layer of ink capable of reflecting light.

### BACKGROUND

Labels may be utilized in a variety of applications to identify items. In some applications, a number of labels may include the same graphics content (text, characters or other images) and, in other applications, each label may be individualized. To provide such graphics content, be it individually or in batches, a number of labels may be positioned on a single liner or on individual liners, which may be in the form of a strip or sheet, and fed into a printer. The printer may utilize sensors, which are capable of detecting the position of a label within the printer. The printer may then adjust the position of the label where necessary, and apply graphics content. Positioning may be performed, for example, with reference to slots or holes cut into the label liner.

In addition, various scanners, sensors or detectors may be utilized to read the information placed onto the label. In some cases, such scanners, sensors or detectors may also utilize a light emitting source and a light detecting source to read the identifying information placed onto the label. Once again, the scanners, sensors or detectors may utilize the contrast between the information placed on the label and the label substrate itself to identify the label information.

### SUMMARY OF THE INVENTION

An aspect of the present disclosure relates to a label. The label may include a substrate including a first surface and a second surface opposite to the first surface. An adhesive may contact at least a portion of the first surface, a liner may contact at least a portion of the adhesive and a reflective layer may contact at least a portion of the second surface. The reflective layer may include a binder and a reflective flake. The liner may have a first reflectivity R₁ and the label may have a second reflectivity R₂. The label may reflect 10% to 50% of light incident to said label and R₁≠R₂.

Another aspect of the present disclosure relates to a method for providing reflective labels. The method may include providing a substrate including a first surface and a second surface opposite to the first surface, disposing an adhesive on at least a portion of the first surface, contacting at least a portion of the adhesive with a liner, and disposing a reflective ink on at least a portion of the second surface. The reflective ink may include a binder, a solvent and a reflective flake. The liner may have a first reflectivity R₁ and the label may have a second reflectivity R₂. The label may reflect 10% to 50% of incident light to said label and R₁≠R₂.

A further aspect of the present disclosure relates to a system for sensing reflective labels. The system may include a label comprising a substrate including a first surface and a second surface opposite the first surface, an adhesive contacting at least a portion of the first surface, a liner contacting at least a portion of the adhesive, and a reflective layer including a reflective flake contacting at least a portion of the second surface. The liner may have a first reflectivity R₁ and the label may have a second reflectivity R₂, wherein the label reflects 10% to 50% of incident light and R₁≠R₂. The system may also include a light emitter configured to emit light onto the label and a light detector configured to detect light reflected from the label.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1a is an example of a label contemplated herein;

FIG. 1b is another example of a label contemplated herein; and

FIG. 2 is an example of a system including a label and a sensor.

### DETAILED DESCRIPTION

It is to be understood that this disclosure is not limited in its application to the details of construction and the arrangement of components set forth in the following description or illustrated in the drawings. The embodiments herein are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

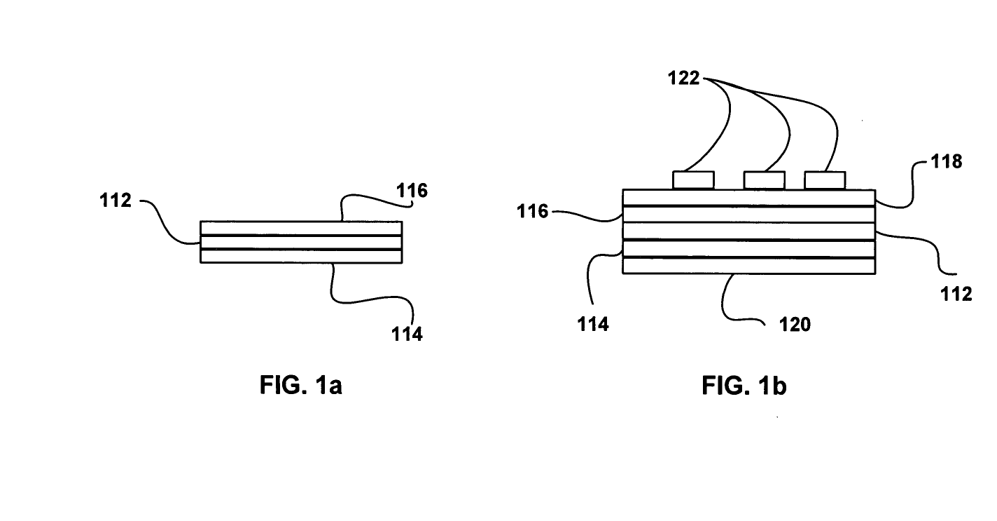

The present disclosure relates to a label including a reflective material, wherein the label may be capable of reflecting 10% to 50% of incident light. As illustrated in FIG. 1a, the label 110 may include a number of layers, such as a substrate 112, an adhesive 114 disposed on a first surface of the substrate and a reflective layer 116 disposed on a second surface of the substrate opposite to the first surface. The label may optionally include, as illustrated in FIG. 1b, a top coat 118 and a liner 120. Furthermore, various graphics 122, may be provided on the reflective layer 116 either directly or indirectly, wherein, for example, the top coat 118 may intervene. Graphics may be understood as characters such as text or numbers, figures including lines, and/or various shapes. The graphics may be provided in a variety of colors in the visible spectrum including black and/or white.

The substrate 112 may be a film or sheet, which may include thermoplastic materials, paper, or fabric including thermoplastic materials and/or natural materials, etc. Thermoplastic materials may include polyethylene, polypropylene, polyester, vinyl, acetate, polystyrene, etc. Natural materials may include cotton, cellulose based materials, etc. In one example, at least 50% of incident light in the visible range, i.e., in the range of 350 to 780 nm, including all values and increments therein may pass through the substrate. Incident light may be understood as direct light that falls on a surface. In another example, the substrate may be any color, reflecting a portion of incident light in the visible range corresponding to, for example, red, orange, green, blue, indigo, purple and/or various shades, hues, tints and combinations thereof. While, the substrates herein may be white, i.e., reflecting substantially all, or at least 90% of incident light in the visible spectrum, including all values and increments in the range of 90% to 99.9%, it may be appreciated that the substrates herein need not be white and in some examples are not white. Furthermore, the substrates herein may be black in color, absorbing a relatively significant portion of light, such as greater than 90% of incident light in the visible spectrum, including all values and increments in the range of 90% to 99.9%. In addition, the substrate may be combinations of various colors, including black and/or white, and include portions through which varying degrees of light may pass.

An adhesive 114 may be disposed either directly or indirectly on at least a portion of one surface of the substrate 112. The adhesive may be a pressure sensitive adhesive, which may include starch, casein, acrylates, polyvinyl acetate, polyvinyl alcohol, amino resins, or elastomeric materials such as polybutadiene or polyisoprene, etc. It is contemplated that other adhesives may be used herein as well. The adhesive may be disposed or applied to the substrate by a number of processes including spray coating, dip coating, flexographic printing, gravure printing, etc.

A reflective layer 116 may be disposed either directly or indirectly on at least a portion of a surface of the substrate 112. In one example, as illustrated, the reflective layer 116 may be disposed on the side opposite the adhesive layer 114. In another example, the reflective layer may be between the adhesive and the substrate. The reflective layer 116 may be applied as an ink by a number of coating processes such as flexographic printing, gravure printing, spray coating, etc. The ink may exhibit a viscosity in the range of 20 cps to 50 cps, including all values and increments therein. In one example, the ink may be a dispersion including a binder, a solvent and a reflective flake as well as various optional additives. The ink may also include colorants such as pigments or dyes. In one example, the ink may have a PANTONE value of #877.

The binder may be a polymeric type material and based on urethane, styrene, acrylics, amines, maleic anhydride, epoxy ester resin, polyester, combinations thereof, etc. The binder may be dispersed in a solvent, such as water; however, other solvents may be contemplated herein as well. In addition, various dispersants may be used, such as dispersants based on ammonia or amines. Furthermore, various co-solvents to reduce surface tension, plasticizers, waxes, and/or anti-foaming agents may be present.

The reflective flake may include a metal, non-metal or polymer flake material. Metal flake may include, for example, aluminum, silver, nickel, copper, zinc, platinum, rhodium, gold, or tantalum. Non-metal flakes may include polycrystalline titanium dioxide or mica coated with titanium dioxide or ferric oxide. The reflective flake may have an average particle size across the largest dimension in the range of 2 μm to 100 μm, including all values and increments therein. In addition, the reflective flake may have a thickness in the range of 0.1 μm to 2.0 μm, including all values and increments therein. It may be appreciated that the flakes may be any geometry or shape. The reflective flake may be present in the ink in the range of 5% to 50% by weight, including all values and increments therein, such as 10% to 20% by weight.

The ink may be solidified by curing or drying on the substrate. Curing may include UV curing or otherwise crosslinking the ink composition. Drying may be performed at ambient temperatures, as well as at elevated temperatures. When the ink solidifies upon the substrate, the reflective flake may be present in the range of 10% to 90% by weight of the reflective layer, including all values and increments therein.

A top coat 118 may also be provided over or disposed on the reflective layer 116. The top coat may be a relatively transparent coating. For example, at least 80% of incident light, including all values and increments in the range of 80% to 100%, may pass through the top coat. In another example, the refractive index of the top coat may be less than 2.00, including all values and increments in the range of 1.0 to 2.0, as measured at 589 nm. The top coat may be formed of, for example, polypropylene, polyethylene, polyester, etc. The top coat may be applied in dispersion or as a film.

A liner 120 or backing may be provided to contact a least a portion of the adhesive opposite to the substrate. The liner may be paper or a film liner, including polymeric films. The liner may also be coated with a release coat, such as silicone, which may aid in removing the liner from the adhesive layer.

Various graphics may be applied to the labels herein. As alluded to above, the graphics may include various characters such as text, numbers or symbols, or images. The graphics may be applied either directly or indirectly onto the reflective layer. For example, a top coat may be provided upon which the graphics are applied or the graphics may be applied underneath a top coat. The graphics may be applied by a variety of printing methods, including flexographic printing, gravure printing, screen printing, relief printing, thermal transfer printing, direct thermal printing, electrophotographic printing, inkjet printing, etc. A number of colors may be used in printing the graphics, such as those of the visible spectrum, including black and white, as well as those in the infrared spectrum, i.e., 750 nm to 2500 nm, or ultraviolet spectrum, i.e., 100 nm to 400 nm. In addition, the graphics may include reflective pigments as well.

At least a portion of the label may have a reflectivity R of 10% to 50% incident light at wavelengths in the range of 100 nm to 2500 nm, including all values and increments therein, such as wavelengths in the visible range, i.e., 350 nm to 780 nm, the infrared range, i.e., 750 nm to 2500 nm, or the ultraviolet range, i.e., 100 nm to 400 nm. In such a manner, regardless of the underlying substrate, the reflective layer may reflect a sufficient amount of light that the label and at least a portion of the graphics on the label may be sensed by a sensor, scanner or detector, herein after referred to as a sensor, and may be located in printers, barcode readers, or other image scanners or detectors. Reflectivity may be measured by a number of techniques, including spectroscopy.

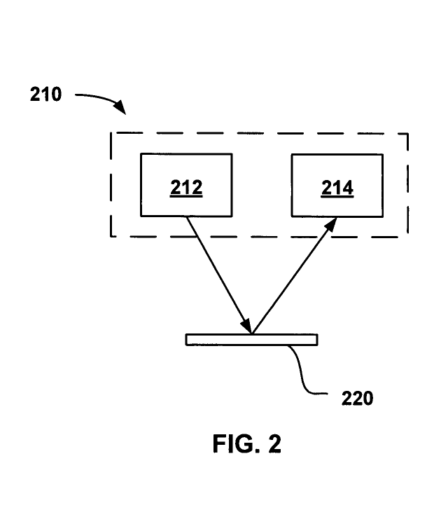

As illustrated in FIG. 2, the sensor 210 may include a light emitter 212, configured to illuminate at least a portion a label 220, and a light detector 214, configured to detected incident light reflected from the label 220. It may be appreciated that while the sensor 210 including the light emitter 212 and light detector 214 is illustrated as a single unit, the sensor 210 may be two or more separate units. Furthermore, the sensor may include more than one light emitter and/or more than one light detector, which may be capable of emitting and detecting light at more than one wavelength or range of wavelengths. The detector 214 may convert the light signal to an electronic signal, which may be directed to a processor 216. Based on differences in the reflected light detected, the processor 216 may discern, for example, the presence of a label or the graphics presented on a label.

The light emitter may be capable of emitting light at one or more wavelengths or ranges of wavelengths, including those in the visible range, i.e., 350 nm to 780 nm, the infrared range, i.e., 750 nm to 2500 nm, or the ultraviolet range, i.e., 100 nm to 400 nm. The emitter may include various light sources such as an LED. The detector may be capable of detecting or sensing light at one or more wavelengths or ranges of wavelengths, including those in the visible range, i.e., 350 nm to 780 nm, the infrared range, i.e., 750 nm to 2500 nm, or the ultraviolet range, i.e., 100 nm to 400 nm. Detectors may include photodetectors, such as photomultipliers, photodiodes, charged coupled devices, etc.

As alluded to above, the sensor may be located in a printing device, for registration or positioning of the labels within the printer. In such a manner, individual labels may be placed on individual liners or on a continuous liner. The labels and liner may be provided in a roll of labels, which may be inserted into an image forming device. The liner may have a first reflectivity R₁ and reflect light emitted from the emitter differently than the label having a second reflectivity R₂, wherein R₁≠R₂. For example, the reflectivity of the label may be less than or greater than that of the liner. When a difference is sensed in light detected by the detector, the printer may be able to determine the location of the label with respect to the printer and image forming aspects of the printer. The printer may then adjust the label accordingly, i.e., by advancing or retracting the label, for proper printing.

In addition, the sensor may be a scanner, such as a barcode reader. Light may be emitted onto the label surface. The graphics presented on the label may contrast with the reflective portion of the label, i.e., reflect incident light differently. The label may have a reflectivity R₂ and the graphics may have a reflectivity R₃, wherein R₂≠R₃. For example, the reflectivity R₂ of the label may be greater than that of the graphics R₃. Thus, when a difference is sensed in the light detected by the detector due to the graphics, the detector may send a signal to a processor, which may discern at least a portion of the graphics on the label.

The foregoing description of several methods and embodiments has been presented for purposes of illustration. It is not intended to be exhaustive or to limit the claims to the precise steps and/or forms disclosed, and obviously many modifications and variations are possible in light of the above teaching. It is intended that the scope of the invention be defined by the claims appended hereto.

What is claimed is:

1. A label, comprising:
a substrate including a first surface and a second surface opposite said first surface;
an adhesive contacting at least a portion of said first surface;
a liner contacting at least a portion of said adhesive, wherein said liner has a first reflectivity R₁; and
a reflective layer contacting at least a portion of said second surface, wherein said reflective layer includes a binder and a reflective flake, wherein said label has a second reflectivity R₂ and reflects 10% to 50% of light incident to said label, wherein R₁≠R₂.

2. The label of claim 1, wherein said incident light is at wavelengths in the range of 750 nm to 2500 nm.

3. The label of claim 1, wherein said reflective flake is 2 μm to 100 μm.

4. The label of claim 1, wherein said reflective flake is metallic.

5. The label of claim 1, wherein said reflective flake may be present in the reflective layer in the range of 10% to 90% by weight of the reflective layer.

6. The label of claim 1, wherein said substrate comprises a thermoplastic material.

7. The label of claim 1, wherein at least a portion of said substrate transmits at least 50% of incident light.

8. The label of claim 1, wherein at least a portion of said substrate absorbs at least 50% of incident light in the visible spectrum.

9. The label of claim 1, wherein said adhesive is a pressure sensitive adhesive.

10. The label of claim 1, further comprising graphics.

11. A method for providing reflective labels, comprising:
providing a substrate including a first surface and a second surface opposite to said first surface;
disposing an adhesive on at least a portion of said first surface;
contacting at least a portion of said adhesive with a liner, wherein said liner has a first reflectivity R₁; and
disposing a reflective ink on at least a portion of said second surface, wherein said reflective ink comprises a binder, a solvent and a reflective flake, wherein said label has a second reflectivity R₂ and reflects 10% to 50% of incident light to said label, wherein R₁≠R₂.

12. The method of claim 11, wherein said incident light is at one or more wavelengths in the range of 750 nm to 2500 nm.

13. The method of claim 11, further comprising disposing a top coat on said reflective ink.

14. The method of claim 11, further comprising providing graphics on said reflective ink.

15. The method of claim 11, wherein said reflective flake is metallic flake.

16. The method of claim 11, wherein said reflective flake is in the range of 2 μm to 100 μm.

17. The method of claim 11, wherein at least a portion of said substrate transmits at least 50% of incident light.

18. The method of claim 11, wherein at least a portion of said substrate absorbs at least 50% of incident light in the visible spectrum.

19. A system for sensing reflective labels, comprising:
a label comprising a substrate including a first surface and a second surface opposite said first surface, an adhesive contacting at least a portion of said first surface, a liner contacting at least a portion of said adhesive having a first reflectivity R₁, and a reflective layer including a reflective flake contacting at least a portion of said second surface, wherein said label has a second reflectivity R₂ and reflects 10% to 50% of incident light, wherein R₁≠R₂;
a light emitter configured to emit light onto said label; and
a light detector configured to detect light reflected from said label.

20. The system of claim 19, wherein said light emitter and light detector are present in a printer, and emit and detect light at wavelengths in the range of 750 nm to 2500 nm.

21. The system of claim 19, wherein said light emitter and light detector are present in a scanner.
